(19) United States
(12) Patent Application Publication
(10) Pub. No.: US 2011/0009539 A1
(43) Pub. Date: Jan. 13, 2011

(54) FLAMEPROOF PMMA MOLDING COMPOUND

(75) Inventors: Thorsten Goldacker, Rossdorf (DE); Klaus Koralewski, Riedstadt (DE); Michael Wicker, Seeheim-Jugenheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK ROEHM GMBH, DARMSTADT (DE)

(21) Appl. No.: 12/865,242

(22) PCT Filed: Feb. 26, 2009
(86) PCT No.: PCT/EP09/52238

§ 371 Date: Jul. 29, 2010

(30) Foreign Application Priority Data
Apr. 17, 2008 (DE) 102008001231.9

(51) Int. Cl. C07F 9/6571; B29C 45/00

(52) U.S. Cl. 524/119; 264/328.1

(57) ABSTRACT

The invention relates to a flameproof PMMA moulding material, mouldings produced therefrom and the use thereof. Small amounts of an organo-phosphorus compound are sufficient to increase the glow wire flammability index by 300° C.

The invention relates to a flameproof PMMA moulding material, mouldings produced therefrom and the use thereof.

Moulding materials based on polymethyl methacrylate (PMMA) are used for a variety of applications. For this purpose, the materials are usually extruded or injection moulded to give shaped articles. These mouldings are distinguished by the typical PMMA properties, such as a colourless appearance and high transparency, weathering resistance, heat distortion resistance, outstanding mechanical characteristics, such as tensile modulus and good stress cracking resistance.

The field of use of extruded or coextruded PMMA mouldings is very wide; thus, extruded or coextruded sheets are used both outdoors, in particular for add-on automotive parts, components, surfaces of sports articles and lamp covers, and indoors, in particular in the furniture industry, for lamp covers and interior trims of automobiles.

Certain applications require passing corresponding tests for flameproof properties. Thus, for example, housings and covers of lamps, in particular of escape route lighting, must have a glow wire flammability index of at least 850° C. PMMA has a flammability which is normal for plastics; the flammability index in the glow wire test is 650° C. and is therefore in need of improvement for the abovementioned requirements. In order to increase the flame resistance, various measures can be taken; in particular, there are a number of additives which have a flame-retardant effect without adversely affecting the other properties, such as colourless appearance and transparency or decomposition-free processing.

As long ago as the early 1980s, Sandoz developed a flameproofing agent which has a certain flame-retardant effect in the case of certain PMMA moulding materials (U.S. Pat. No. 4,458,045). This is 2,2′-[[2,2-bis(chloromethyl)propane-1,3-diyl]bis(oxy)]bis[5,5-dimethyl-1,3,2-dioxaphosphorinane]-2,2′-dioxide, which was earlier commercially available under the name Sandoflam® 5085 and is now commercially available under the name Exolit® 5085 (from Clariant). In the case of other PMMA moulding materials, in particular high molecular weight PMMA moulding materials, such as PLEXIGLAS® 7H, however, adequate flame resistance is not achieved with this flameproofing agent.

In WO 03/037975, inter alia Exolit 5085 together with tris(2-chloroisopropyl) phosphate is used as a flame-resistant additive for PMMA. A disadvantage of the halogenated alkyl phosphate used there is the low decomposition temperature, which is below the processing temperature of about 250° C. customary for PMMA moulding materials. WO 03/037975 therefore describes the thermoplastic processing of the additive-containing PMMA moulding material only up to a temperature of 235° C. However, such a low processing temperature has various disadvantages, such as, for example, longer cycle times during injection moulding and reduced throughputs during extrusion.

In addition, several publications (EP-A-1013713, WO 00/37557) describe a blend of PMMA and PVC as a flameproof moulding material. Here, PVC acts as a halogen-containing flameproofing agent. However, the decomposition temperature of PVC is likewise below the customary processing temperature of PMMA moulding materials, so that there are once again disadvantages in the processing. Moreover, the presence of PVC has an adverse effect on the weathering resistance of the blend.

In view of the abovementioned disadvantages, it is now the object to provide a moulding material which is based on, substantially high molecular weight, (meth)acrylate(co)polymers, passes the glow wire test according to IEC 60695-2-10:2000 with a glow wire flammability index of at least 850° C. and nevertheless is thermally stable and resistant to weathering. The object is achieved by the addition of a further low molecular weight (meth)acrylate(co)polymer and of an organophosphorus compound, as defined below.

The invention relates to a moulding material containing
A) 50 to 98.9% by weight of at least one (meth)acrylate(co)polymer having a solution viscosity number (VN) of 60 to 100 ml/g,
B) 0.1 to 49% by weight of at least one (meth)acrylate(co)polymer having a solution viscosity number (VN) of 10 to 50 ml/g and
C) 1 to 30% by weight of at least one organophosphorus compound of the general formula I

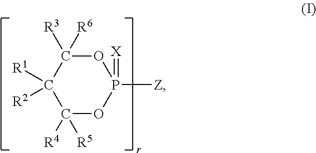

in which
R¹ and R², independently of one another, are C₁-C₄-alkyl or phenyl,
R³ and R⁴, independently of one another, are hydrogen or C₁-C₄-alkyl,
R⁵ and R⁶, independently of one another, are hydrogen or methyl,
X is oxygen,
r is 2, 3 or 4,
—Z— is

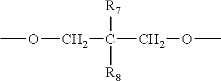

for r=2,
is

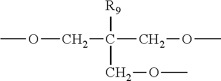

for r=3,
is

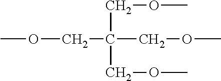

for r=4,
   in which
R₇, R₈ and R₉, independently of one another, denote halogenated C₁-C₄-alkyl,
the proportions of A), B) and C) in the moulding material according to the invention summing to 100.0% by weight and the VN being measured in chloroform at 25° C. (ISO 1628-6:1990 (E)).

The expression (meth)acrylate comprises methacrylates and acrylates and mixtures of the two. These monomers are widely known.

The (meth)acrylate(co)polymer A) is preferably a homopolymer or copolymer of at least 80.0% by weight of methyl methacrylate and optionally up to 20.0% by weight of further monomers copolymerizable with methyl methacrylate. The (meth)acrylate(co)polymer A) preferably consists of 90.0 to 99.5% by weight, particularly preferably 93.0 to 98.0% by weight, of methyl methacrylate units and of further comonomers units in a total amount of preferably 0.5 to 10.0% by weight, particularly preferably of 2.0 to 7.0% by weight. Suitable comonomers capable of free radical polymerization are, for example, other acrylates, methacrylates and/or vinylaromatics. Preferably used comonomers are C₁-C₄-alkyl(meth)acrylates, in particular methyl acrylate, ethyl acrylate and/or butyl acrylate, methyl acrylate being particularly preferred.

A very particularly preferably used high molecular weight (meth)acrylate-(co)polymer A) is a copolymer of 96% by weight of methyl methacrylate and 4% by weight of methyl acrylate.

The high molecular weight (meth)acrylate(co)polymers A) have a solution viscosity number (VN) in chloroform at 25° C. (ISO 1628-6:1990 (E)) of 60 to 100 ml/g, preferably of 65 to 90 ml/g, preferably of 67 to 80 ml/g. A copolymer of 96% by weight of methyl methacrylate and 4% by weight of methyl acrylate having a solution viscosity number of 71 cm³/g is very particularly preferred. Such a copolymer is commercially available as PLEXIGLAS® 7H from Evonik Röhm GmbH.

The (meth)acrylate(co)polymer B) is preferably a homopolymer or copolymer of at least 50% by weight of methyl methacrylate and optionally up to 50% by weight of further monomers copolymerizable with methyl methacrylate. The (meth)acrylate(co)polymer B) preferably consists of at least 80% by weight, particularly preferably of at least 95% by weight, of methyl methacrylate units and of further comonomer units in a total amount of preferably up to 20% by weight, particularly preferably of up to 5% by weight. Suitable comonomers capable of free radical polymerization are, for example, other acrylates, methacrylates and/or vinylaromatics. Preferably used comonomers are C₁-C₄-alkyl (meth)acrylates, in particular methyl acrylate, ethyl acrylate and/or butyl acrylate, methyl acrylate being particularly preferred.

A very particularly preferably used low molecule weight (meth)acrylate-(co)polymer B) is a copolymer of 99% by weight of methyl methacrylate and 1% by weight of methyl acrylate.

The low molecular weight (meth)acrylate(co)polymer B) is characterized by a solution viscosity in chloroform at 25° C. (DIN ISO 1628-6:1990 (E)) of 10 to 50 ml/g, preferably 20 to 50 ml/g, in particular 25 to 45 ml/g. According to a preferred embodiment, B) is a copolymer of 99% of methyl methacrylate and 1% of methyl acrylate having a solution viscosity number of 40 ml/g.

The components A) and B) can be obtained in a known manner by free radical polymerization.

Organophosphorus compounds of the formula I, in which
R¹ and R² are C₁-C₄-alkyl,
R³ and R⁴ are hydrogen,
R⁵ and R⁶ are hydrogen,
X is oxygen,
r is 2,
Z is

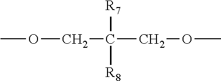

and
R₇ and R₈, independently of one another, are —CH₂—X where X is Cl or Br, are preferably used as component C).

Organophosphorus compounds of the formula Ia

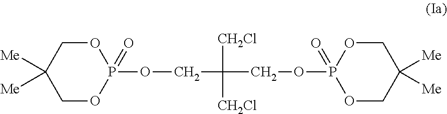

which are commercially available under the name Exolit® 5085 are particularly preferably used. The preparation of the organophosphorus compounds of the formula I is described in U.S. Pat. No. 4,458,045.

The proportion of A) in the moulding material according to the invention is preferably 70.0 to 94.5% by weight, particularly preferably 75 to 89% by weight. The proportion of B) in the moulding material according to the invention is preferably 0.5 to 25% by weight, particularly preferably 1 to 10% by weight. The proportion of C) in the moulding material according to the invention is preferably 5 to 25% by weight, particularly preferably 10 to 20% by weight.

The proportions of A), B) and C) in the moulding material according to the invention sum to 100.0% by weight, it being possible for the moulding material additionally to contain customary additives, auxiliaries and/or fillers in customary amounts.

Customary additives, auxiliaries and/or fillers are, for example, heat stabilizers, UV stabilizers, UV absorbers, antioxidants, colorants (soluble and/or insoluble ones, such as pigments) and/or lubricants and mould release agents. The abovementioned additives may be present in the moulding material according to the invention in amounts of 0.0001% by weight to 1.5% by weight, especially in amounts of 0.001% by weight to 1.0% by weight, in particular in amounts of 0.01% by weight to 0.5% by weight, the total amount of the additives not being permitted to exceed 5% by weight.

The moulding material according to the invention may be transparent or non-transparent, depending on the optionally used additives.

The moulding material according to the invention may be prepared by dry blending of the components A), B) and C), which may be present as powders, particles or preferably granules. Furthermore, it can also preferably be prepared by melting and mixing the components A), B) and C) in the molten state or by melting dry premixes of individual components A) and B) and adding the component C). This can be effected, for example, in single-screw or twin-screw extruders. The extrudate obtained can then be granulated. The above-mentioned customary additives, auxiliaries and/or fillers can be directly admixed or can be added later by the end user as required.

The moulding material according to the invention is suitable as a starting material for the production of mouldings. The moulding of the moulding material can be effected in a manner known per se, for example by processing via the elastoviscous state, i.e. by kneading, rolling, calendering, extrusion or injection moulding, extrusion and injection moulding being preferred.

The injection moulding of the moulding material can be effected in a manner known per se at temperatures in the range of 220° C.-310° C. (melt temperature), preferably 250-280° C., and a mould temperature of preferably 60° C. to 90° C.

The extrusion is preferably carried out at a temperature of 200° C. to 260° C.

The mouldings obtainable in this manner are distinguished in particular by the following properties:

The glow wire flammability index, determined by the glow wire test according to IEC 695-2-1, is at least 850° C., preferably 960° C.

The transmittance, determined according to ISO 13468-2:1999 (E), is preferably in the range from 40% to 93%, particularly preferably in the range from 55% to 93%, in particular in the range from 55% to 85%. The half-value angle according to DIN 5036 is preferably in the range from 1° to 55°, particularly preferably in the range from 2° to 40°, in particular in the range from 8° to 37°.

The mouldings according to the invention can be used as components in the electrical industry, for example as lamp covers. They are used in particular for housings or covers of escape route lighting since a glow wire flammability index of the housing material of at least 850° C. is absolutely essential for these.

### EXAMPLES

Below, the invention is explained in more detail by examples without it being intended to limit the concept of the invention thereby.

The standard moulding material PLEXIGLAS® 7H from Evonik Röhm GmbH (solution viscosity number VN=71 cm³/g) was mixed with a copolymer of 99% by weight of MMA and 1% by weight of methyl acrylate having a solution viscosity number VN=40 cm³/g and additionally 15% of Exolit® 5085 (from Clariant). For this purpose, the two polymers in the form of granules and the flameproofing agent were in each case extruded twice in a 15 mm Stork single-screw extruder at 230° C. and granulated. The crystal clear and colourless compounds were injection moulded to give 65×40×3 mm rectangular panels and subjected to the glow wire test according to IEC 695-2-1.

| Example | Polymer ratio A):B) | Exolit ® 5085/ | |
|---|---|---|---|
| No. | Plexiglas ® 7H:Copo 99-1 | % by weight | GWFI*/° C. |
| Comparison | 100:0 | 15 | 650 |
| 1 | 98.75:1.25 | 15 | 960 |
| 2 | 97.50:2.50 | 15 | 960 |
| 3 | 95.00:5.00 | 15 | 960 |

*GWFI = glow wire flammability index

The measured data mentioned in the above table show that even small proportions of the component B) in the moulding material are sufficient to increase the glow wire flammability index by 300° C. compared with a moulding material without the component B).

1: A moulding material comprising
A) 50 to 98.9% by weight of at least one (meth)acrylate(co)polymer having a solution viscosity number (VN) of 60 to 100 ml/g,
B) 0.1 to 49% by weight of at least one (meth)acrylate(co)polymer having a solution viscosity number (VN) of 10 to 50 ml/g and
C) 1 to 30% by weight of at least one organophosphorus compound represented by formula I 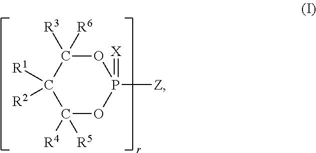
in which
R¹ and R², independently of one another, are C₁-C₄-alkyl or phenyl,
R³ and R⁴, independently of one another, are hydrogen or C₁-C₄-alkyl,
R⁵ and R⁶, independently of one another, are hydrogen or methyl,
X is oxygen,
r is 2, 3 or 4,
—Z— is 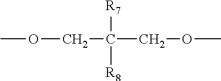
for r=2,
is 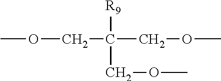
for r=3,
is 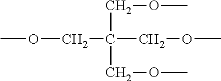
for r=4,
in which
R₇, R₈ and R₉, independently of one another, denote halogenated C₁-C₄-alkyl,
the proportions of A), B) and C) summing to 100.0% by weight and the VN is measured in chloroform at 25° C. (ISO 1628-6:1990 (E)).

2: The moulding material according to claim 1, wherein the proportion of component A) is 70 to 94.5% by weight, the proportion of the component B) is 0.5 to 25% by weight and the proportion of the component C) is 5 to 25% by weight.

3: A moulding material according to claim 1, wherein the component A) is a (meth)acrylate(co)polymer having a VN of 65 to 90 ml/g and component B) is a (meth)acrylate(co)polymer having a VN of 20 to 50 ml/g.

4: The moulding material according to claim 3, wherein component A) has a VN of 67 to 80 ml/g and component B) a VN of 25 to 45 ml/g.

5: The moulding material according to claim 1, wherein the component A) is a homopolymer or copolymer of at least 80.0% by weight of methyl methacrylate and optionally up to 20.0% by weight of at least one further monomer copolymerizable with methyl methacrylate.

6: The moulding material according to claim 5, wherein A) is a copolymer of 90.0 to 99.5% by weight of methyl methacrylate and 0.5 to 10.0% by weight of at least one C₁-C₄-alkyl (meth)acrylate.

7: The moulding material according to claim 1, wherein the component B) is a homopolymer or copolymer of at least 50.0% by weight of methyl methacrylate and optionally up to 50.0% by weight of at least one further monomer copolymerizable with methyl methacrylate.

8: The moulding material according to claim 7, wherein the component B) is a copolymer of at least 80.0% by weight of methyl methacrylate and up to 20.0% by weight of at least one C₁-C₄-alkyl (meth)acrylate.

9: The moulding material according to claim 1, wherein:
R¹ and R² are C₁-C₄-alkyl,
R³ and R⁴ are hydrogen,
R⁵ and R⁶ are hydrogen,
X is oxygen,
r is 2,
Z is 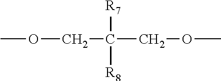
and
R₇ and R₈, independently of one another, are —CH₂—X′ where X′═Cl or Br.

10: The moulding material according to claim 9, wherein C) is an organophosphorus compound represented by formula Ia

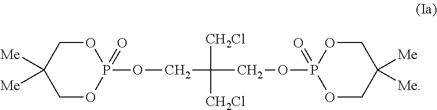

11: The moulding material according to claim 1, wherein a glow wire flammability index (IEC 695-2-1) of at least 850° C.

12: The moulding material according to claim 1, further comprising customary additives, auxiliaries and/or fillers in customary amounts.

13: A process for the production of mouldings, comprising extruding on injection molding a moulding material according to claim 1.

14: A moulding which can be prepared by a process according to claim 13.

15: (canceled)
